(19) United States
(12) Patent Application Publication
(10) Pub. No.: US 2007/0071504 A1
(43) Pub. Date: Mar. 29, 2007

(54) Image forming apparatus and developer transporting apparatus therefor

(75) Inventors: Sang-don Lee, Gwacheon-si (KR); In-yong Song, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/525,028

(22) Filed: Sep. 22, 2006

(30) Foreign Application Priority Data
Sep. 29, 2005 (KR) 2005-91373

(51) Int. Cl. G03G 15/08

(52) U.S. Cl. 399/258

(57) ABSTRACT

An image forming apparatus having an image forming part to apply developer to a recording medium to form an image, the image forming apparatus including a developer transporting pipe through which developer is transported to the image forming part, a first storing part to store a first amount of the developer and to supply the developer to an upstream part of the developer transporting pipe, at least a second storing part to store at least a second amount of the developer and to supply the developer to a downstream part of the developer transporting pipe, and a transporting device, disposed along the developer transporting pipe, to transport the developer supplied by the first storing part and the second storing part to the image forming part with the upstream part of the developer transporting pipe having a different transport flow rate than the downstream part of the developer transporting pipe.

### CROSS-REFERENCE TO RELATED APPLICATION

This application claims the benefit of Korean Patent Application No. 2005-91373, filed Sep. 29, 2005, in the Korean Intellectual Property Office, the disclosure of which is incorporated herein by reference.

### BACKGROUND OF THE INVENTION

1. Field of the Invention

An aspect of the present invention relates to an image forming apparatus, and, more particularly, to an image forming apparatus and a developer transporting apparatus, installed in the image forming apparatus, in which an amount of developer that is stored in a plurality of developer storing parts may be effectively controlled.

2. Description of the Related Art

Generally, an image forming apparatus forms an image, which is processed by an image processing apparatus such as a host computer, by printing the image information on a printing paper. The image forming apparatus may be classified into an electrophotographic type, in which an image is formed by an application of developer to an electrostatic latent image formed on a photosensitive element by a potential difference and then by a transfer of the electrostatic latent image to a recording medium (i.e., printing paper, transparency), an inkjet type, in which an image is formed by a discharging of ink onto the recording medium through a multiplicity of inkjet nozzles, a thermal transfer type, in which an image is formed by a selective heating of an ink ribbon that contacts the recording medium, and other types. The electrophotographic type of image forming apparatuses is widely adopted, however, because of the advantages of high printing speeds, high resolution, and low costs this type provides.

The electrophotographic type of image forming apparatuses comprises a developer storing part. Generally, the developer storing part is detachably attached to a main body of the image forming apparatus. When the developer is used up, the developer storing part is detached from the main body of the image forming apparatus and a new developer storing part filled a new supply of developer is attached to the main body of the image forming apparatus.

Generally, the developer storing part includes a large storing space to store a large amount of developer so that frequent replacement of the developer storing part is not required. However, even during infrequent replacement of the developer storing part, the use of the developer storing part with a single developer is still inconvenient because of a size and weight thereof, and easy attachment to and detachment from the main body of the image forming apparatus remains difficult. Accordingly, a developer storing part with a plurality of containers has been used.

FIG. 1 shows a schematic view of a conventional image forming apparatus. As shown in FIG. 1, the image forming apparatus 101 comprises an image forming part 110, a first developer storing part 130, a second developer storing part 140, a developer transporting pipe 120 and a transporting screw 150. The image forming part 110 comprises a photosensitive part (not shown), a developing roller (not shown) and a transfer roller (not shown). The image forming part 110 forms an electrostatic latent image, develops the electrostatic latent image with the developer supplied through the developer transporting pipe 120, and transfers the developed image to a recording medium to form an image.

The first developer storing part 130 and the second developer storing part 140 each store the developer. The first developer storing part 130 supplies the developer to an upstream part 122 of the developer transporting pipe 120, and the second developer storing part 140 supplies the developer to a downstream part 124 of the developer transporting pipe 120. The transporting screw 150 is disposed at the developer transporting pipe 120 to supply the developer supplied to the developer transporting pipe 120 to the image forming part 110 and includes a transporting screw blade 154 formed along the axial direction of the rotating shaft 152.

However, according to the conventional image forming apparatus 101, the developer, which is stored in the second developer storing part 140, may not be as easily supplied to the image forming part 110 as the developer stored in the first developer storing part 130. That is, as the developer supplied to the upstream part 122 by the first developer storing part 130 is transported by the transporting screw 150 to occupy the transporting space at the downstream part 124 of the developer supplying pipe 120, the developer stored in the second developer storing part 140 may not be easily supplied to the downstream part 124 of the developer transporting pipe 120.

Accordingly, in the conventional image forming apparatus 101, as the developer consumption from the first developer storing part 130 is larger than that from the second developer storing part 140 due to the non-uniformity in the supply of the developer between the plurality of developer storing parts 130 and 140, controlling the stored amount of the developer may be difficult.

### SUMMARY OF THE INVENTION

Accordingly, it is an aspect of the present invention to provide an image forming apparatus in which an amount of developer that is stored in a plurality of developer storing parts may be effectively controlled.

The foregoing and/or other aspects of the present invention may be achieved by providing an image forming apparatus having an image forming part to apply developer to a recording medium to form an image, the image forming apparatus comprising: a developer transporting pipe through which developer is transported to the image forming part; a first storing part to store a first amount of the developer and to supply the developer to an upstream part of the developer transporting pipe; at least a second storing part to store at least a second amount of the developer and to supply the developer to a downstream part of the developer transporting pipe; and a transporting device, disposed along the developer transporting pipe, to transport the developer supplied by the first storing part and the second storing part to the image forming part with the upstream part of the developer transporting pipe having a different transport flow rate than the downstream part of the developer transporting pipe.

According to another aspect of the present invention, the transporting device comprises a transporting screw.

According to another aspect of the present invention, the transporting screw comprises a rotating shaft and a transporting screw blade extending spirally from the rotating shaft, the transporting screw blade having a pitch which is different at the upstream part of the developer transporting pipe than at the downstream part of the developer transporting pipe.

According to another aspect of the present invention, the transporting screw comprises a rotating shaft and a transporting screw blade extending spirally from the rotating shaft, the transporting shaft having a diameter at the upstream part of the developer transporting pipe that is different from a diameter of the transporting shaft at the downstream part of the developer transporting pipe.

According to another aspect of the present invention, the developer transporting pipe has a diameter which is different at the upstream part than at the downstream. part.

According to another aspect of the present invention, the first storing part comprises a first supply opening to supply the developer to the upstream part of the developer transporting pipe, the second storing part comprises a second supply opening to supply the developer to the downstream part of the developer transporting pipe, wherein the first supply opening is different in size from the second supply opening.

The foregoing and/or other aspects of the present invention are also achieved by providing a developer transporting apparatus comprising: a developer transporting pipe; a first storing part to store a first amount of developer and to supply the developer to an upstream part of the developer transporting pipe; at least a second storing part to store a second amount of developer and to supply the developer to a downstream part of the developer transporting pipe; and a transporting device disposed at the developer transporting pipe to transport the developer supplied by the first storing part and the second storing part through the developer transporting pipe with the upstream part of the developer transporting pipe having a different transport flow rate from the downstream part of the developer transporting pipe.

According to another aspect of the present invention, the transporting device comprises a transporting screw.

According to another aspect of the present invention, the transporting screw comprises a rotating shaft and a transporting screw blade extending spirally from the rotating shaft, the transporting screw blade having a pitch which is different at the upstream part of the developer transporting pipe than at the downstream part of the developer transporting pipe.

According to another aspect of the present invention, the transporting screw comprises a rotating shaft and a transporting screw blade extending spirally from the rotating shaft, the transporting shaft having a diameter at the upstream part of the developer transporting pipe that is different from a diameter of the transporting shaft at the downstream part of the developer transporting pipe.

According to another aspect of the present invention, the developer transporting pipe has a diameter which is different at the upstream part than at the downstream part.

According to another aspect of the present invention, the first storing part comprises a first supply opening to supply the developer to the upstream part of the developer transporting pipe, the second storing part comprises a second supply opening to supply the developer to the downstream part of the developer transporting pipe, wherein the first supply opening is different in size from the second supply opening.

Additional and/or other aspects and advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic view of a conventional image forming apparatus.

FIG. 2 is a schematic view of an image forming apparatus according to a first embodiment of the present invention.

FIG. 3 is a perspective view of a transporting screw of the image forming apparatus in FIG. 2.

FIGS. 4A and 4B are graphs showing a change in the supply amount of a developer using the image forming apparatus in FIG. 2.

FIG. 5 is a perspective view of the image forming apparatus according to a second embodiment of the present invention.

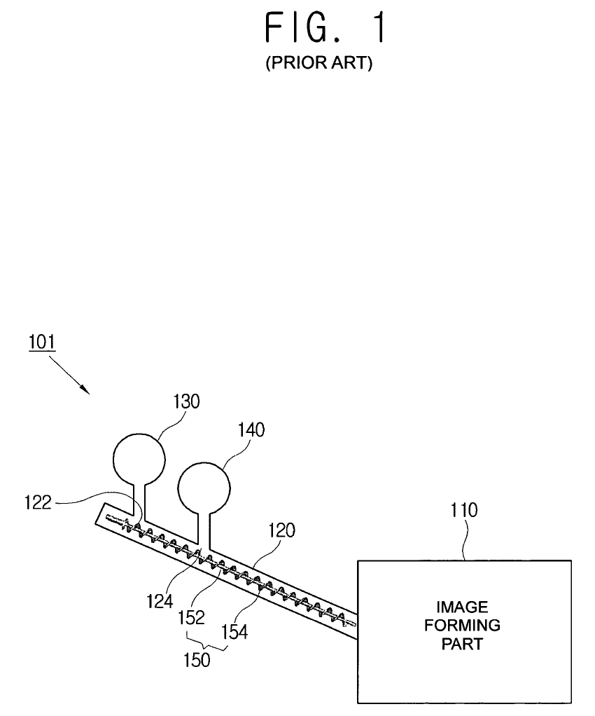

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

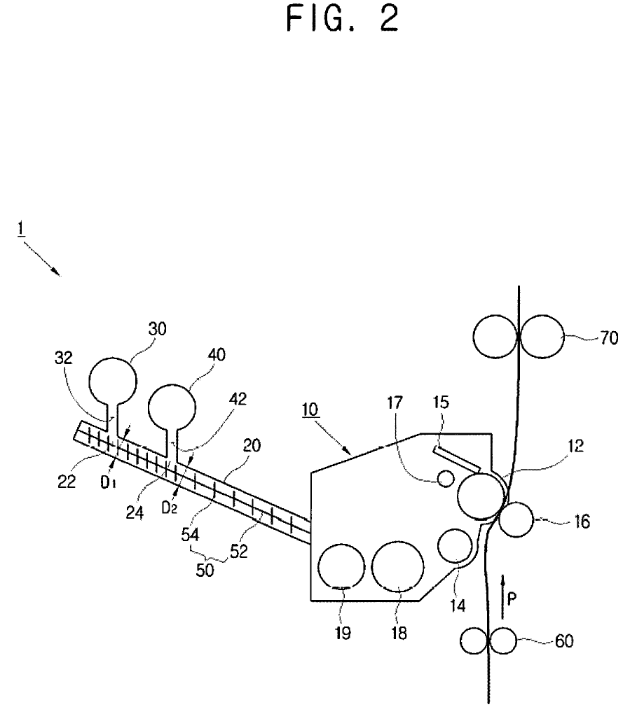

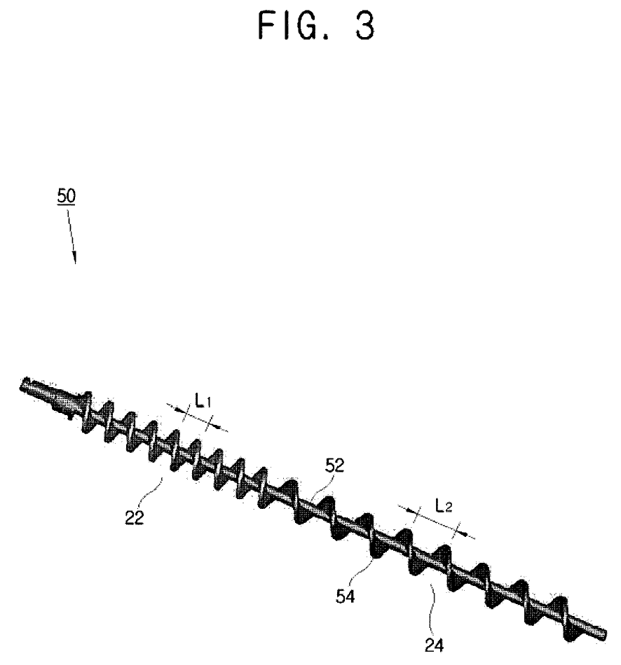

As shown in FIGS. 2 and 3, an image forming apparatus 1 according to a first embodiment of the present invention comprises an image forming part 10 which applies developer to a printing paper P (i.e., paper, transparency) to form an image. Also, the image forming apparatus 1 comprises a developer transporting pipe 20 to transport the developer to the image forming part 10, a first developer storing part 30 to store the developer and to supply the developer to an upstream part 22 of the developer transporting pipe 20, a second developer storing part 40 to store the developer and to supply the developer to a downstream part 24 of the developer transporting pipe 20, and a transporting screw 50 that is disposed in the developer transporting pipe 20 to transport the developer, which is supplied by the first storing part 30 and the second storing part 40, to the image forming part 10 so that the upstream part 22 may have a relatively small transport flow rate compared with the downstream part 24.

The image forming part 10 comprises a photosensitive element 12, a developing roller 14, a transfer roller 16, a cleaning blade 15, a charging roller 17, a supply roller 18 and an agitator 19. The photosensitive element 12 receives light scanned by a light scanning unit (not shown) and forms an electrostatic latent image thereon. The developing roller 16 applies the developer to the electrostatic latent image formed on the photosensitive element 12 to develop an image. The transfer roller 16 transfers the developer, applied on the photosensitive element 12, to the recording medium P which proceeds between the photosensitive element 12 and the transfer roller 16. The cleaning blade 15 removes the developer remaining on the photosensitive element 12 after the transfer, and the charging roller 17 charges the photosensitive element 12 to have a uniform voltage across a longitudinal length thereof. The supply roller 18 supplies the developer to the developing roller 14, and the agitator 19 stirs the developer transported through the developer transporting pipe 20.

The image forming apparatus 1 further comprises a feeding roller 60 and a fixing roller 70. The feeding roller 60 supplies the recording medium P to the image forming part 10. The fixing roller 70 receives the printing paper P from the image forming part 10 and applies heat and pressure to the developer on the recording medium P to fix the developer on the recording medium P.

The developer transporting pipe 20 receives the developer from the first storing part 30 and the second storing part 40 and transports the developer to the image forming part 10. The developer transporting pipe 20 is inclined downwardly from the upstream part 22 to the downstream part 24 and to the image forming part 10 so that the developer may be transported to the image forming part 10 by the transporting screw 50 and force of gravity. In alternate embodiments, however, the developer may be transported by only the transporting screw 50, in which case the developer transporting pipe 20 may be disposed horizontally or inclined upwardly.

The first storing part 30 and the second storing part 40 store the developer. The first storing part 30 supplies the developer to the upstream part 22 of the developer transporting pipe 20. The first storing part 30 has a first supply opening 32 through which the developer is supplied to the upstream part 22. The second storing part 40 supplies the developer to the downstream part 24 of the developer transporting pipe 20. The second storing pipe 40 has a second supply opening 42 through which the developer is supplied to the downstream part 24.

The first storing part 30 and the second storing part 40 respectively have a substantially spherical storing space to store a predetermined amount of the developer. The first storing part 30 and the second storing part 40 may be able to store equal amounts of developer or different amounts. The first storing part 30 and the second storing part 40 are, in an embodiment of the invention, detachably combined to the developer transporting pipe 20 respectively. When the developer stored in the first storing part 30 or the second storing part 40 is used up, the empty one of the storing parts 30 or 40 may be detached from the developer transporting pipe 20 and then replaced with a new storing part filled with developer. In alternate embodiments, one or both of the storing parts 30 and/or 40 may be integrally combined to the developer transporting pipe 20.

The transporting screw 50 transports the developer, which is supplied to the developer transporting pipe 20 by the first storing part 30 and the second storing part 40, to the image forming part 10 by rotation about a longitudinal axis thereof At the downstream part 24 of the developer transporting pipe 20 where the developer from the second storing part 40 is supplied, the transporting screw 50 joins the developer from the first storing part 30 with the developer supplied by the second storing part 40, and transports the joined developer to the image forming part 10.

The transporting screw 50 comprises a rotating shaft 52 and a transporting screw blade 54 that extends spirally from the rotating shaft 52. The transporting screw blade 54 has a pitch L1 at the upstream part 22 which is shorter than a pitch L2 at the downstream part 24. The rotating shaft 52 is rotatably disposed in the extending direction of the developer transporting pipe 20 so that the rotating shaft 52 may include at least a section of the developer transporting pipe 20 between the point where the first storing part 30 supplies the developer and the point where the second storing part 40 supplies the developer. The transporting screw blade 54 extends spirally from the rotating shaft 52 in a direction where the developer is transported to the image forming part 10 as the rotating shaft 52 rotates.

In accordance with an embodiment of the invention, the pitch of the transporting screw blade 54 gradually lengthens along the axis of the rotating shaft 52 from the upstream part 22 to the downstream part 24. In contrast, in alternative embodiments, the transporting screw blade 54 may have various pitches at various specific sections along the axis of the rotating shaft 52. In these alternative embodiments, however, the transporting screw blade 54 still has a pitch which is shorter at the upstream part 22 than at the downstream part 24.

While the rotating shaft 52 rotates once, the developer transport distance of the transporting screw blade 54 is longer at the upstream part 22 than at the downstream part 24. As such, the transporting screw blade 54 has a developer transport flow rate which is larger at the downstream part 24 than at the upstream part 22. This results in the fact that the transporting screw blade 54 relatively easily transports the developer supplied by the second storing part 40, as well as the developer supplied by the first storing part 30 to the image forming part 10.

Therefore, during a use of the image forming apparatus 1, the situation in which the developer, which is supplied by the first storing part 30, occupies most of the transport space resulting in the developer of the second storing part 40 not being supplied to the downstream part 24 and then to the image forming apparatus 1, may be prevented. Accordingly, the developer consumption amount between the first storing part 30 and the second storing part 40 may be substantially uniform. Thus, the developer storage amount may be easily controlled. For example, the frequency of change of the developer storing part 30 may be lowered.

Although the developer transporting pipe 20 in FIG. 2 has a uniform diameter along a longitudinal axis thereof, the developer transporting pipe 20 may have a diameter at the upstream part 22, which is different from a diameter thereof at the downstream part 24. That is, the developer transporting pipe 20 may have a diameter D1 at the upstream part 22 which is smaller than a diameter D2 at the downstream part 24. Accordingly, since the developer transport space at the upstream part 22 of the developer transporting pipe 20 may be smaller than that at the downstream part 24, the transporting screw 50 may provide an even larger developer transport flow rate at the downstream part 24 than the developer transport flow rate at the upstream part 22.

According to additional embodiments of the invention, the first supply opening 32 may be smaller than the second supply opening 42. In this case, the transporting screw 50 provides a developer transport flow rate at the downstream part 24 which is larger than the developer transport flow rate at the upstream part 22. According to this embodiment, the discharging amount of the developer per unit of time at the upstream part 22 by the first supply opening 32 is smaller than the discharging amount of the developer per unit of time at the downstream part 24. In this case, the developer consumption amount of the first storing part 30 is equal to that of the second storing part 40.

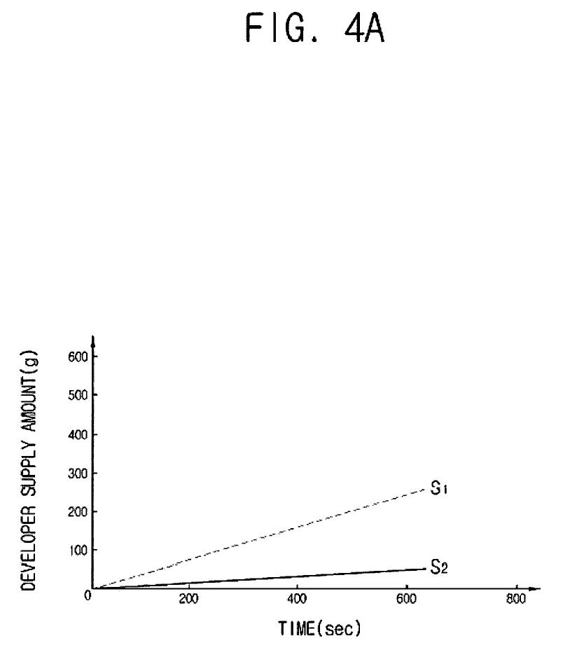

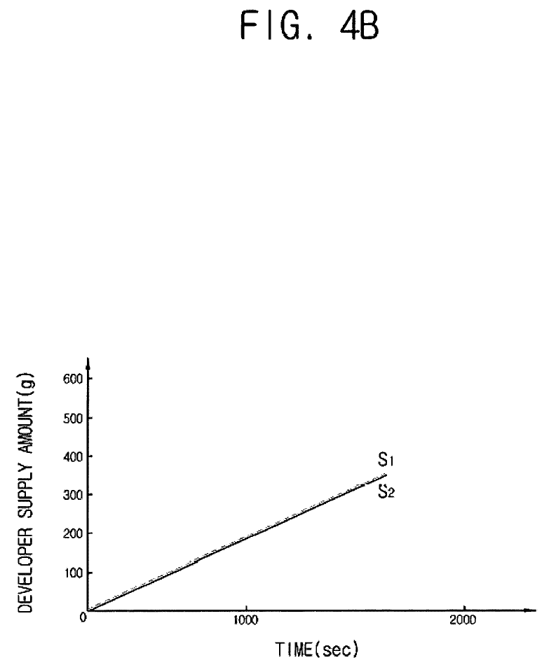

Hereinafter, an operation of the image forming apparatus according to the first embodiment of the present invention will be described with reference to FIGS. 4A and 4B.

FIGS. 4A and 4B are graphs showing the change in the supply amount of the developer using the image forming apparatus in FIG. 2. In particular, FIG. 4A is a graph which shows the developer supply amounts of the first and second storing parts 30 and 40 when the pitch of the transporting screw blade 54 is uniform along the extending direction of the developer transporting pipe 20 and FIG. 4B is a graph which shows the developer supply amounts of the first and second storing parts 30 and 40 when the pitch of the transporting screw blade 54 at the upstream part 22 is smaller than the pitch of the transporting screw blade 54 at the downstream part 24. Line S1 shows the developer supply amount according to time in the first storing part 30 which supplies the developer to the upstream part 22. Line S2 shows the developer supply amount according to time in the second storing part 40 which supplies the developer to the downstream part 24.

As shown in FIG. 4A, the developer supply amount of the first storing part 30 is remarkably larger than that of the second storing part 40. However, in FIG. 4B, the developer supply amount of the first storing part 30 is the same as that of the second storing part 40. Therefore, the developer supply amount between the first and the second storing parts 30 and 40 is shown to be effectively controlled by adjusting the pitch of the transporting screw blade 54 of the transporting screw 50.

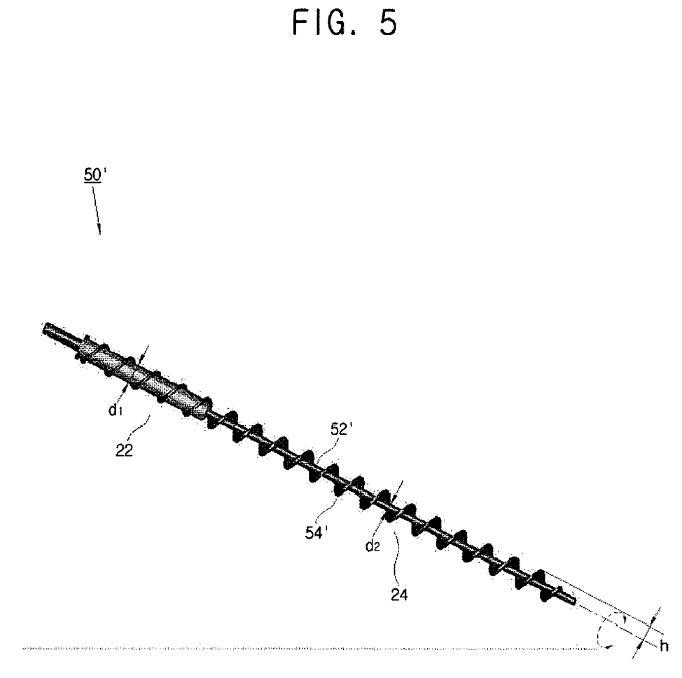

Hereinafter, the image forming apparatus according to a second embodiment of the present invention will be described referring to FIG. 5.

FIG. 5 is a perspective view of the image forming apparatus according to the second embodiment of the present invention. As shown in FIG. 5, the transporting screw 50′ comprises a rotating shaft 52′ and a transporting screw blade 54′ extending spirally from the rotating shaft 52′. A diameter d1 of the rotating shaft 52′ at the upstream part 22 is larger than a diameter d2 of the rotating shaft 52′ at the downstream part 24. The distance between the center axis line of the rotating shaft 52′ and the thread of the transporting screw blade 54′, that is, the height h of the transporting screw blade 54′ is the same both at the upstream part 22 and at the downstream part 24. As a result, the developer transporting flow rate of the transporting screw 50′ is smaller at the upstream part 22 than at the downstream part 24.

Here, the height h of the transporting screw blade 54′ may be adjusted along the direction of the axis of the rotating shaft 52′. For example, the height h of the transporting screw blade 54′ may be higher at the upstream part 22 than at the downstream part 24.

Although the image forming apparatus according to the embodiments of the present invention has two developer storing parts, the image forming apparatus according to aspects of the present invention may have three or more developer storing parts as long as the developer storing parts are disposed along the extending direction of a developer transporting pipe and supply the developer.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An image forming apparatus having an image forming part to apply developer to a recording medium to form an image, the image forming apparatus comprising:
a developer transporting pipe through which developer is transported to the image forming part;
a first storing part to store a first amount of the developer and to supply the developer to an upstream part of the developer transporting pipe;
at least a second storing part to store at least a second amount of the developer and to supply the developer to a downstream part of the developer transporting pipe; and
a transporting device, disposed along the developer transporting pipe, to transport the developer supplied by the first storing part and the second storing part to the image forming part with the upstream part of the developer transporting pipe having a different transport flow rate from the downstream part of the developer transporting pipe.

2. The image forming apparatus according to claim 1, wherein the transporting device comprises a transporting screw.

3. The image forming apparatus according to claim 2, wherein the transporting screw comprises a rotating shaft and a transporting screw blade extending spirally from the rotating shaft, the transporting screw blade having a pitch which is different at the upstream part of the developer transporting pipe from the downstream part of the developer transporting pipe.

4. The image forming apparatus according to claim 2, wherein the transporting screw comprises a rotating shaft and a transporting screw blade extending spirally from the rotating shaft, the transporting shaft having a diameter at the upstream part of the developer transporting pipe that is different from a diameter of the transporting shaft at the downstream part of the developer transporting pipe.

5. The image forming apparatus according to claim 2, wherein the developer transporting pipe has a diameter which is different at the upstream part from the downstream part.

6. The image forming apparatus according to claim 2, wherein the first storing part comprises a first supply opening to supply the developer to the upstream part of the developer transporting pipe, the second storing part comprises a second supply opening to supply the developer to the downstream part of the developer transporting pipe, and wherein the first supply opening is different in size from the second supply opening.

7. A developer transporting apparatus comprising:
a developer transporting pipe;
a first storing part to store a first amount of developer and to supply the developer to an upstream part of the developer transporting pipe;
at least a second storing part to store a second amount of developer and to supply the developer to a downstream part of the developer transporting pipe; and
a transporting device disposed at the developer transporting pipe to transport the developer supplied by the first storing part and the second storing part through the developer transporting pipe with the upstream part of the developer transporting pipe having a different transport flow rate from the downstream part of the developer transporting pipe.

8. The developer transporting apparatus according to claim 7, wherein the transforming device comprises a screw.

9. The developer transporting apparatus according to claim 8, wherein the screw comprises a rotating shaft and a transporting screw blade extending spirally from the rotating shaft, the transporting screw blade having a pitch which is different at the upstream part of the developer transporting pipe than at the downstream part of the developer transporting pipe.

10. The developer transporting apparatus according to claim 8, wherein the transporting screw comprises a rotating shaft and a transporting screw blade extending spirally from the rotating shaft, the transporting shaft having a diameter at the upstream part of the developer transporting pipe that is different from a diameter of the transporting shaft at the downstream part of the developer transporting pipe.

11. The developer transporting apparatus according to claim 8, wherein the developer transporting pipe has a diameter which is different at the upstream part than at the downstream part.

12. The developer transporting apparatus according to claim 8, wherein the first storing part comprises a first supply opening to supply the developer to the upstream part of the developer transporting pipe, the second storing part comprises a second supply opening to supply the developer to the downstream part of the developer transporting pipe, and wherein the first supply opening is different in size from the second supply opening.

13. An image forming apparatus having an image forming part to apply developer to a recording medium to form an image, the image forming apparatus comprising:
a developer transporting pipe through which developer is transported to the image forming part;
a first storing part to store a first amount of the developer and to supply the developer to the developer transporting pipe at a first position along the developer transporting pipe;
at least a second storing part to store at least a second amount of the developer and to supply the developer to the developer transporting pipe at a second position of the developer transporting pipe, the second position being downstream of the first position; and
a transporting device, disposed along the developer transporting pipe, to transport the developer supplied by the first and second storing parts to the image forming part in substantially similar amounts.

14. The image forming apparatus according to claim 13, wherein either the first and second storing parts supply the developer to the developer transporting pipe in equal quantities or the first storing part supplies the developer to the developer transporting pipe in a lesser quantity than the second storing part.

15. The image forming apparatus according to claim 14, wherein, if the first and second storing parts supply the developer in equal quantities, the developer transporting pipe transports, developer between the first and second storing parts at a slower rate than between the second storing part and the image forming part.

16. The image forming apparatus according to claim 15, wherein the transporting device comprises a screw, including a rotating shaft and a spiral blade that moves developer along a length of the transporting device while rotating about the rotating shaft.

17. The image forming apparatus according to claim 16, wherein the spiral blade has at least a first pitch between the first and second storing parts and a second pitch between the second storing part and the image forming part, the second pitch being longer than the first pitch.

18. The image forming apparatus according to claim 16, wherein the rotating shaft has a larger diameter between the first and second storing parts than between the second storing part and the image forming part.

19. The image forming apparatus according to claim 14, wherein, if the first storing part supplies the developer to the developer transporting pipe in a lesser quantity than the second storing part, the developer transporting pipe transports developer between the first and second storing parts at either a slightly slower rate than between the second storing part and the image forming part or at an equal rate.

20. The image forming apparatus according to claim 14, wherein an opening between the developer transporting pipe and the first storing part is smaller than an opening between the developer transporting pipe and the second storing part.
